(19) United States
(12) Patent Application Publication
(10) Pub. No.: US 2004/0096745 A1
(43) Pub. Date: May 20, 2004

(54) Lithium ion conductor and all-solid lithium ion rechargeable battery

(75) Inventors: Yasuyuki Shibano, Osaka (JP); Kazuya Iwamoto, Osaka (JP)

Correspondence Address: MCDERMOTT, WILL & EMERY, 600 13th Street, N.W., WASHINGTON, DC, 20005-3096, US

(73) Assignee: MATSUSHITA ELECTRIC INDUSTRIAL CO., LTD.

(21) Appl. No.: 10/702,491

(22) Filed: Nov. 7, 2003

(30) Foreign Application Priority Data
Nov. 12, 2002 (JP) JP2002-328476

(51) Int. Cl. C01B 21/20

(52) U.S. Cl. 429/322; 423/385

(57) ABSTRACT

A lithium ion conductor is prepared from a composite oxide containing Li, Ta and N and/or a composite oxide containing Li, Ta, Nb and N.

### BACKGROUND OF THE INVENTION

In recent years, high-performance small-sized devices and parts, such as IC cards, electronic tags, small sensors and micromachines for medical use, have been developed actively. Accordingly, batteries used as a power source are required to have high reliability, reduced thickness and size. To meet the requirements, thin film batteries, especially all-solid lithium ion rechargeable batteries using an inorganic solid electrolyte, have been actively studied. Bates et al. of Oak Ridge National Laboratory (ORNL) have reported an all-solid battery using LiPON as a solid electrolyte. LiPON is a lithium ion conductor made of nitrogen-introduced Li₃PO₄ obtained by sputtering Li₃PO₄ in nitrogen atmosphere. LiPON has ion conductivity of about 1×10⁻⁶ S/cm. Further, there has also been developed a thin battery comprising LiCoO₂ as a positive electrode, LiPON as a solid electrolyte and metallic Li as a negative electrode which are stacked on an Si or Al₂O₃ base plate by sputtering (e.g., see the specification of U.S. Pat. No. 5,597,660).

On the other hand, as a thin film having high ion conductivity, Le Qung Nguyen et al. have produced a thin film having ion conductivity of 2.5×10⁻⁵ S/cm by sputtering LiNbO₃ in nitrogen atmosphere (see Le Qung Nguyen, “Thin Solid Film”, 1997, Vol. 293, pp. 175-178).

However, if the solid electrolyte LiPON is combined with a positive electrode such as LiCoPO₄ that charges and discharges at high voltages, or with LiCoO₂ to carry out a cycle test at a high temperature of about 80° C., decomposition of LiPON becomes remarkable and the cycle characteristics deteriorate drastically. Accordingly, as long as LiPON is used as the solid electrolyte in the manufacture of an all-solid lithium ion rechargeable battery, choices of the positive electrode material are reduced and the cycle life is shortened.

On the other hand, if the ion conductivity of the solid electrolyte is low, resistance in the electrolyte portion becomes high and favorable high-current discharge performance cannot be obtained. For these reasons, a solid electrolyte material having high ion conductivity and high decomposition voltage has been demanded.

### BRIEF SUMMARY OF THE INVENTION

Under the above-described circumstances, the present invention has been achieved. One aspect of the present invention is to provide a lithium ion conductor having high ion conductivity and high decomposition voltage. Another aspect of the present invention is to provide an all-solid lithium ion rechargeable battery excellent in cycle characteristics and high-current discharge performance by making use of the lithium ion conductor.

In other words, the present invention relates to a lithium ion conductor comprising a composite oxide containing Li, Ta and N. The present invention further relates to a lithium ion conductor comprising a composite oxide containing Li, Ta, Nb and N.

If the composition of the composite oxide is represented by the general formula: LiₐNb_{b}Ta_{c}O_{d}Nₑ, it is preferable that the general formula satisfies 0.1≦a≦2.5, 0≦b<1, 0<c≦1, b+c=1, 0.1≦d≦5 and 0.1≦e≦2.

It is more preferable that the general formula further satisfies 0.1≦e≦1.

Further, the present invention provides an all-solid lithium ion rechargeable battery comprising a positive electrode, a negative electrode and a solid electrolyte interposed between the positive electrode and the negative electrode, wherein the solid electrolyte comprises a lithium ion conductor film and the lithium ion conductor film comprises the above-described composite oxide of the present invention.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a sectional view of an example of an all-solid lithium ion rechargeable battery according to the present invention.

### DETAILED DESCRIPTION OF THE INVENTION

A lithium ion conductor of the present invention may be in a crystalline state, but in general, it is preferably in a vitreous state. A vitreous substance mentioned herein is a substance in which an atomic, ionic or molecular arrangement does not have a long-range order, the structure is similar to that of liquid and no anisotropy is found in its physical properties.

The lithium ion conductor of the present invention has a composition of LiTaO₃ or a composite of LiTaO₃ and LiNbO₃, in which oxygen is substituted with nitrogen. These oxides show improvement in ion conductivity and increase in decomposition voltage by introducing nitrogen in their structures.

There is no particular limitation as to how to prepare the lithium ion conductor of the present invention, but for example, the following methods are suitable for obtaining a thin film of the lithium ion conductor.

A first preferable method adopts high frequency sputtering. In this method, sputtering is performed in nitrogen gas atmosphere using LiTaO₃ or a mixture of LiTaO₃ and LiNbO₃ in which nitrogen is not introduced as a target. As a result of such a sputtering step, a thin vitreous film comprising a composite oxide containing Li, Ta and N or a composite oxide containing Li, Ta, Nb and N is obtained. As the target, an elementary substance of Li, Ta or Nb, or an oxide or nitride of Li, Ta or Nb may also be used.

A second preferable method adopts vapor deposition. According to this method, vapor deposition is carried out in nitrogen gas atmosphere with use of LiTaO₃ or a mixture of LiTaO₃ and LiNbO₃ as a source. According to such a vapor deposition step, a thin vitreous film comprising a composite oxide containing Li, Ta and N or a composite oxide containing Li, Ta, Nb and N is obtained. There is no particular limitation as to how to evaporate the source, but for example, resistant heating, electron beam method and the like may be adopted. As the source, may also be used an elementary substance of Li, Ta or Nb, or an oxide or nitride of Li, Ta or Nb.

A lithium ion conductor may be formed by other methods than the above, such as laser abrasion, ion plating, CVD (chemical vapor deposition), sol-gel method, screen printing and mechanical milling. A person skilled in the field of composite oxides would freely select a material suitable for the manufacturing method and establish suitable conditions to obtain a desired composite oxide.

A composition of the lithium ion conductor of the present invention may be represented by the general formula: LiₐNb_{b}Ta_{c}O_{d}Nₑ. The general formula preferably satisfies 0.1≦a≦2.5, 0≦b<1, 0<c≦1, b+c=1, 0.1≦d≦5 and 0.1≦e≦2. It is more preferable that the general formula satisfies 0.1≦e≦1.

The more preferable ranges of the parameters a to e are 0.5≦a≦2, 0≦b≦0.95, 0.05≦c≦1, 1.25≦d≦3.35 and 0.1≦e≦1.

If the values deviate from the above ranges, there may be caused reduction in ion conductivity of the lithium ion conductor, increase in activation energy and decrease in decomposition voltage. In particular, in the case where e<0.1 or 2<e, the mobility of lithium ions is apt to decrease, reducing the ion conductivity. The most preferable range of e is 0.12≦e≦0.82.

Where c=0 is satisfied in the general formula, i.e., the lithium ion conductor does not contain Ta, the ion conductivity becomes as low as about 2.5×10⁻⁵ S/cm. However, if Nb is substituted with Ta having almost the same ionic radius and ionic valence as those of Nb, the ion conductivity and the decomposition voltage improve to a great extent.

The lithium ion conductor of the present invention may be applied to gas sensors, electrochromic devices, all-solid batteries and the like. Among them, it is suitably used as a solid electrolyte of the all-solid lithium ion rechargeable batteries.

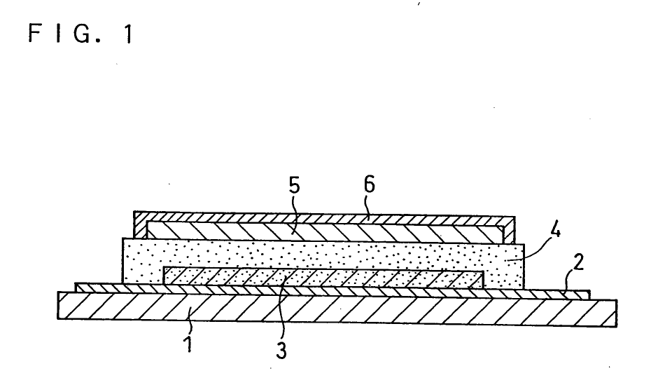

FIG. 1 shows a sectional view of an example of an all-solid lithium ion rechargeable battery.

The battery of FIG. 1 includes a positive electrode current collector 2, a positive electrode 3, a solid electrolyte 4, a negative electrode 5 and a negative electrode current collector 6 which are formed on a base plate 1 in this order. The positive electrode 3 is entirely covered with the solid electrolyte 4. The negative electrode 5 and the negative electrode current collector 6 are separated from the positive electrode 3 and the positive electrode current collector 2 by the solid electrolyte 4 interposed therebetween.

If the lithium ion conductor of the present invention is used as the solid electrolyte 4, an all-solid lithium ion rechargeable battery is obtained with favorable cycle characteristics and high-current discharge performance. In FIG. 1, only a single cell is formed on the base plate. However, it is of course possible to manufacture an all-solid lithium ion rechargeable battery by stacking two or more cells.

The all-solid lithium ion rechargeable battery may be manufactured by sequentially forming films of the positive electrode, negative electrode and the like on the base plate. The film formation may be carried out by sputtering, vapor deposition, electron beam deposition, laser abrasion, ion plating, CVD, sol-gel method, screen printing or the like. If necessary, battery components such as the positive and negative electrodes may be crystallized by heat treatment or the like.

In order to manufacture a battery as shown in FIG. 1, it is preferable to use Pt, Au, Fe, Ni, Cu, Al, stainless steel (SUS), Al₂O₃, Si, SiO₂, polyethylene terephthalate (PET) or the like as the base plate. However, there is no particular limitation to the base plate material as long as a thin film can be formed thereon. It is also possible to form a film of the positive electrode current collector or negative electrode current collector on various circuit boards.

As the positive electrode current collector, Pt, Cu, Ni, Ti and Co are preferably used, but they are not limitative. In FIG. 1, the positive electrode current collector is in contact with the base plate, but it is also possible to make the negative electrode current collector contact with the base plate. The above-listed materials for the positive electrode current collector may also be used as the negative electrode current collector. If a conductive material is used as the base plate, the base plate serves also as the positive electrode current collector or the negative electrode current collector. The positive and negative electrode current collectors have a thickness of 0.1 to 10 μm in general, respectively, but this is not limitative.

Next, a positive or negative electrode film is formed on the positive or negative electrode current collector.

As the positive electrode, are preferably used transition metal oxides such as LiCoO₂, LiNiO₂, LiMn₂O₄, LiNi_{0.4}Mn_{1.6}O₄, LiCo_{0.3}Ni_{0.7}O₂, V₂O₅ and MnO₂, olivine oxides such as LiCoPO₄, LiFePO₄, LiCoPO₄F and LiFePO₄F, lithium titanium oxides having Spinel structure such as Li₄Ti₅O₁₂, Li₄Fe_{0.5}Ti₅O₁₂ and Li₄Zn_{0.5}Ti₅O₁₂, sulfides such as TiS₂ and LiFeS₂ and mixtures thereof. Any material may be used for the positive electrode without any particular limitation as long as it is capable of intercalating and deintercalating lithium ions. The thickness of the positive electrode is 0.1 to 10 μm in general, but this is not limitative.

As the negative electrode, are preferably used alloys comprising Li, Al, Zn, Sn, In or Si, carbon materials such as graphite, lithium titanium oxides having Spinel structure such as Li₄Ti₅O₁₂, Li₄Fe_{0.5}Ti₅O₁₂ and Li₄Zn_{0.5}Ti₅O₁₂, sulfides such as TiS₂, nitrogen compounds such as LiCo_{2.6}O_{0.4}N and mixtures thereof. Any material may be used as the negative electrode without any particular limitation as long as it is capable of intercalating and deintercalating lithium ions. The thickness of the negative electrode is 0.1 to 10 μm in general, but this is not limitative.

Then, a thin film of the above-described lithium ion conductor is formed as a solid electrolyte on the positive or negative electrode. The solid electrolyte film is formed to cover the positive or negative electrode entirely as shown in FIG. 1. The thickness of the solid electrolyte is 0.1 to 10 μm in general, but this is not limitative.

Subsequently, on the solid electrolyte, a negative or positive electrode film is formed as a counter electrode opposing to the positive or negative electrode which has been formed below. Then, a desired current collector film is formed to completely cover the negative or positive electrode film.

Next, detailed explanation is given of the lithium ion conductor and the all-solid lithium ion rechargeable battery according to the present invention by way of examples. However, the present invention is not limited to these examples.

### EXAMPLES

### Example 1

Thin lithium ion conductor films having the compositions shown in Table 1 were formed on base plates by high frequency sputtering.

The sputtering target used was (a) LiTaO₃ or (b) a mixture of LiTaO₃ and LiNbO₃. The size of the target was 4 inches in diameter. The base plate used was a Pt plate. The sputtering was performed in N₂ atmosphere of 15 mTorr. The high frequency output was 200 W.

For the formation of the thin lithium ion conductor film, a mask made of stainless steel (20 μm in thickness) having a square opening was mounted on the base plate so that the thin film was formed in the square shape of 1 cm per side. The thickness of the thin film was 1 μm.

Then, high frequency sputtering was performed using Pt as a target to form a Pt thin film as an electrode on the thin lithium ion conductor film. The size of the target was 3 inches in diameter. The sputtering was performed in Ar atmosphere of 3 mTorr. The high frequency output was 75 W.

According to a complex impedance method, ion conductivities of the obtained thin lithium ion conductor films were measured at room temperature (25° C.). Table 1 shows the results.

TABLE 1

| | | | | | | Conductivity at room |
|---|---|---|---|---|---|---|
| Sample | Composition: LiₐNb_{b}Ta_{c}O_{d}Nₑ | | | | | temperature |
| No. | a | b | c | d | e | [S/cm] |
| 1 | 0.75 | 0 | 1 | 2.1 | 0.5 | 7.0 × 10⁻⁵ |
| 2 | 0.81 | 0.1 | 0.9 | 2.1 | 0.55 | 1.2 × 10⁻⁴ |
| 3 | 0.76 | 0.19 | 0.81 | 2.1 | 0.53 | 1.7 × 10⁻⁴ |
| 4 | 0.85 | 0.33 | 0.67 | 2.2 | 0.49 | 1.9 × 10⁻⁴ |
| 5 | 0.77 | 0.39 | 0.61 | 2.1 | 0.51 | 2.0 × 10⁻⁴ |
| 6 | 0.69 | 0.53 | 0.47 | 2.1 | 0.52 | 1.8 × 10⁻⁴ |
| 7 | 0.6 | 0.6 | 0.4 | 2 | 0.53 | 1.6 × 10⁻⁴ |
| 8 | 0.67 | 0.71 | 0.29 | 2 | 0.54 | 1.5 × 10⁻⁴ |
| 9 | 0.72 | 0.82 | 0.18 | 2 | 0.6 | 1.2 × 10⁻⁴ |
| 10 | 0.77 | 0.89 | 0.11 | 1.9 | 0.67 | 9.0 × 10⁻⁵ |
| 11 | 0.8 | 0.95 | 0.05 | 1.9 | 0.66 | 6.0 × 10⁻⁵ |
| 12 | 0.91 | 1 | 0 | 2 | 0.61 | 2.2 × 10⁻⁵ |
| 13 | 1 | 0 | 1 | 3 | 0 | 9.0 × 10⁻⁸ |
| 14 | 1 | 1 | 0 | 3 | 0 | 6.0 × 10⁻⁹ |
| 15 | 0.68 | 0.71 | 0.29 | 2.8 | 0.06 | 1.2 × 10⁻⁸ |
| 16 | 0.68 | 0.71 | 0.29 | 2.7 | 0.12 | 1.5 × 10⁻⁴ |
| 17 | 0.7 | 0.82 | 0.18 | 2.3 | 0.36 | 1.5 × 10⁻⁴ |
| 18 | 0.75 | 0.89 | 0.11 | 1.6 | 0.82 | 7.5 × 10⁻⁵ |
| 19 | 0.79 | 0.95 | 0.05 | 1.2 | 1.1 | 3.5 × 10⁻⁵ |
| 20 | 0.85 | 0.75 | 0.25 | 0.7 | 1.5 | 3.1 × 10⁻⁵ |

### Comparative Example 1

Thin lithium ion conductor films having the compositions shown in Table 2 were formed on base plates by high frequency sputtering.

The sputtering target used was (c) Li₃PO₄. The size of the target was 4 inches in diameter. The base plate used was a Pt plate. The sputtering was performed in Ar atmosphere of 15 mTorr. The high frequency output was 200 W. In this way, thin lithium ion conductor films were formed in the same manner as Example 1 except that nitrogen was not introduced in the thin films. Then, the ion conductivities of the obtained thin lithium ion conductor films were measured at room temperature (25° C.). Table 2 shows the results.

TABLE 2

| | | | | | | Conductivity at room |
|---|---|---|---|---|---|---|
| Sample | Composition: LiₐP_{c}O_{d}Nₑ | | | | | temperature |
| No. | a | b | c | d | e | [S/cm] |
| 21 | 3 | — | 1 | 4 | 0 | 6.3 × 10⁻⁸ |
| 22 | 3.3 | — | 1 | 3.8 | 0.22 | 1.0 × 10⁻⁶ |

Referring to Tables 1 and 2, high ion conductivities were shown by the thin lithium ion conductor film containing Li, Ta and N but not Nb (sample No. 1) and the thin lithium ion conductor films containing Li, Ta, Nb and N (samples Nos. 2-11) as compared with the thin lithium ion conductor film of LiPON (sample No. 22) and the one containing Li, Nb and N but not Ta (sample No. 12). On the other hand, low ion conductivities were shown by the thin films in which nitrogen was not introduced (samples Nos. 13, 14 and 21).

### Example 2

An all-solid lithium rechargeable battery was fabricated.

### (i) Manufacture of Positive Electrode Current Collector

Explanation is given with reference to FIG. 1. As the base plate, an Si base plate coated with an oxide film (SiO₂) was used. High frequency sputtering was performed using Pt as a target to form a thin Pt film of 0.2 μm in thickness as a positive electrode current collector on the base plate. The sputtering was performed in Ar atmosphere of 3 mTorr. The size of the target was 3 inches in diameter and the high frequency output was 75 W.

For the formation of the thin Pt film, a mask made of stainless steel (20 μm in thickness) having a square opening was mounted on the base plate so that the thin Pt film was formed in the square shape of 1.2 cm per side.

### (ii) Manufacture of Positive Electrode

High frequency sputtering was performed using LiCoO₂ as a target to form a thin LiCoO₂ film of 0.3 μm in thickness as a positive electrode on the positive electrode current collector. The sputtering was performed in mixed atmosphere of Ar of 11 mTorr and O₂ of 4 mTorr. The size of the target was 4 inches in diameter and the high frequency output was 200 W. The temperature of the base plate during the sputtering was kept at 800° C.

For the formation of the thin LiCoO₂ film, a mask made of stainless steel (20 μm in thickness) having a square opening was mounted on the base plate on which the Pt film had been formed so that the thin LiCoO₂ film was formed in the square shape of 1.0 cm per side.

### (iii) Manufacture of Solid Electrolyte

High frequency sputtering was performed using a mixture of 0.4 moles of LiNbO₃ and 0.6 moles of LiTaO₃ as a target to form a thin lithium ion conductor film of 1 μm in thickness as a solid electrolyte on the positive electrode. The sputtering was performed in N₂ atmosphere of 15 mTorr. The size of the target was 4 inches in diameter and the high frequency output was 200 W.

For the formation of the thin lithium ion conductor film, a mask made of stainless steel (20 μm in thickness) having a square opening was mounted on the base plate on which the positive electrode current collector and positive electrode had been formed in sequence so that the thin lithium ion conductor film was formed in the square shape of 1.5 cm per side.

### (iv) Manufacture of Negative Electrode

Resistance heating vacuum vapor deposition was carried out using an artificial graphite (mean particle diameter 25 μm) as a source to form a thin carbon film of 0.5 μm in thickness as a negative electrode on the solid electrolyte. For the formation of the thin carbon film, a mask made of stainless steel (20 μm in thickness) having a square opening was mounted on the base plate on which the positive electrode current collector, positive electrode and solid electrolyte had been formed in sequence so that the thin carbon film was formed in the square shape of 1 cm per side.

### (v) Manufacture of Negative Electrode Current Collector

High frequency sputtering using Cu as a target was performed to form a thin Cu film of 0.5 μm in thickness as a negative electrode current collector on the negative electrode. The sputtering was performed in Ar atmosphere of 4 mTorr. The size of the target was 4 inches in diameter and the high frequency output was 100 W.

For the formation of the thin Cu film, a mask made of stainless steel (20 μm in thickness) having a square opening was mounted on the base plate on which the positive electrode current collector, positive electrode, solid electrolyte and negative electrode had been formed in sequence so that the thin Cu film was formed in the square shape of 1.2 cm per side.

Thus, an all-solid lithium ion rechargeable battery was completed.

### Examples 3-9

All-solid lithium ion rechargeable batteries were fabricated using the same steps and materials as those of Example 2 except that the positive electrodes were formed by high frequency sputtering using LiNiO₂, LiMn₂O₄, LiCoPO₄, LiFePO₄, LiCoPO₄F, LiFePO₄F and LiFeO₂ as targets, respectively.

### Examples 10-18

All-solid lithium ion rechargeable batteries were fabricated using the same steps and materials as those of Example 2 except that the positive electrodes were formed by high frequency sputtering using LiCoO₂, LiNiO₂, LiMn₂O₄, LiCoPO₄, LiFePO₄, LiCoPO₄F, LiFePO₄F, LiFeO₂ and V₂O₅ as targets, respectively, and the negative electrodes were formed by resistance heating vacuum vapor deposition using Li as a source.

### Examples 19-26

All-solid lithium ion rechargeable batteries were fabricated using the same steps and materials as those of Example 2 except that the positive electrodes were formed by high frequency sputtering using LiCoO₂, LiNiO₂, LiMn₂O₄, LiCoPO₄, LiFePO₄, LiCoPO₄F, LiFePO₄F and LiFeO₂ as targets, respectively, and the negative electrodes were formed by high frequency sputtering using Si as a target.

### Examples 27-34

All-solid lithium ion rechargeable batteries were fabricated using the same steps and materials as those of Example 2 except that the positive electrodes were formed by high frequency sputtering using LiCoO₂, LiNiO₂, LiMn₂O₄, LiCoPO₄, LiFePO₄, LiCoPO₄F, LiFePO₄F, LiFeO₂ and V₂O₅ as targets, respectively, and the negative electrodes were formed by high frequency sputtering using Li₄Ti₅O₁₂ as a target.

### Example 35

An all-solid lithium ion rechargeable battery was fabricated using the same steps and materials as those of Example 2 except that the positive electrode was formed by high frequency sputtering using V₂O₅ as a target and the negative electrode was formed by resistance heating vacuum vapor deposition using LiCo_{2.6}O_{0.4}N as a source.

### Comparative Examples 2-35

All-solid lithium ion rechargeable batteries were fabricated using the same steps and materials as those of Examples 2-35 except that LiPON was used as the solid electrolyte.

### Evaluations and Results

### (i) Cycle Characteristics

All-solid rechargeable batteries fabricated in Examples 2-35 and those fabricated in Comparative Examples 2-35 were subjected to a charge-discharge test. More specifically, the batteries were subjected to 1000 charge-discharge cycles at 80° C., under charge current of 4 C and discharge current of 20 C. Table 3 shows a capacity maintenance ratio (a percentage of capacity after 1000 cycles to the initial capacity), end-of-charge voltage and end-of-discharge voltage obtained at that time.

### (ii) High-Current Discharge Performance

Table 3 also shows the capacity ratios when the discharge currents are 1 C and 20 C, respectively (a percentage of discharge capacity at 20 C rate to discharge capacity at 1 C rate). The reason why the above-described severe conditions were established is to make significant differences between the batteries of Examples and Comparative Examples.

As a result of a component analysis, the composition of the solid electrolyte used in Examples 2-35 was Li_{0.77}Nb_{0.39}Ta_{0.61}O_{2.12}N_{0.51}. The composition of LiPON used in Comparative Examples was Li_{3.3}PO_{3.8}N_{0.22}.

TABLE 3

| | | | | | Capacity | Capacity | | Capacity | Capacity |
|---|---|---|---|---|---|---|---|---|---|
| Positive | Negative | V1* | V2** | | maintenance | ratio | Com. | maintenance | ratio |
| electrode | electrode | (V) | (V) | Ex. | ratio [%] | [%] | Ex. | ratio [%] | [%] |
| LiCoO₂ | C | 4.2 | 3.0 | 2 | 85 | 88 | 2 | 55 | 46 |
| LiNiO₂ | C | 4.2 | 3.0 | 3 | 75 | 77 | 3 | 45 | 43 |
| LiMn₂O₄ | C | 4.2 | 3.0 | 4 | 81 | 85 | 4 | 36 | 34 |
| LiCoPO₄ | C | 5.0 | 4.0 | 5 | 86 | 87 | 5 | 35 | 28 |
| LiFePO₄ | C | 3.9 | 1.8 | 6 | 71 | 73 | 6 | 51 | 43 |
| LiCoPO₄F | C | 5.4 | 4.0 | 7 | 80 | 82 | 7 | 32 | 25 |
| LiFePO₄F | C | 3.9 | 1.8 | 8 | 79 | 79 | 8 | 41 | 29 |
| LiFeO₂ | C | 4.1 | 1.5 | 9 | 77 | 77 | 9 | 51 | 31 |
| LiCoO₂ | Li | 4.3 | 3.0 | 10 | 78 | 79 | 10 | 60 | 52 |
| LiNiO₂ | Li | 4.3 | 3.0 | 11 | 72 | 75 | 11 | 44 | 39 |
| LiMn₂O₄ | Li | 4.3 | 3.0 | 12 | 76 | 80 | 12 | 39 | 31 |
| LiCoPO₄ | Li | 5.1 | 4.0 | 13 | 80 | 82 | 13 | 30 | 25 |
| LiFePO₄ | Li | 4.0 | 1.8 | 14 | 71 | 75 | 14 | 45 | 31 |
| LiCoPO₄F | Li | 5.5 | 4.0 | 15 | 75 | 77 | 15 | 37 | 31 |
| LiFePO₄F | Li | 4.0 | 1.8 | 16 | 72 | 74 | 16 | 57 | 61 |
| LiFeO₂ | Li | 4.2 | 1.5 | 17 | 69 | 72 | 17 | 59 | 58 |
| V₂O₅ | Li | 3.6 | 1.5 | 18 | 85 | 89 | 18 | 60 | 34 |
| LiCoO₂ | Si | 3.9 | 2.6 | 19 | 77 | 79 | 19 | 48 | 43 |
| LiNiO₂ | Si | 3.9 | 2.6 | 20 | 71 | 74 | 20 | 47 | 40 |
| LiMn₂O₄ | Si | 3.9 | 2.6 | 21 | 70 | 71 | 21 | 37 | 30 |
| LiCoPO₄ | Si | 4.7 | 3.6 | 22 | 69 | 73 | 22 | 30 | 27 |
| LiFePO₄ | Si | 3.6 | 1.4 | 23 | 75 | 77 | 23 | 49 | 42 |
| LiCoPO₄F | Si | 5.1 | 3.6 | 24 | 74 | 77 | 24 | 34 | 30 |
| LiFePO₄F | Si | 3.6 | 1.4 | 25 | 72 | 73 | 25 | 51 | 49 |
| LiFeO₂ | Si | 3.8 | 1.1 | 26 | 69 | 73 | 26 | 45 | 40 |
| LiCoO₂ | Li₄Ti₅O₁₂ | 2.8 | 1.5 | 27 | 80 | 81 | 27 | 61 | 49 |
| LiNiO₂ | Li₄Ti₅O₁₂ | 2.8 | 1.5 | 28 | 75 | 79 | 28 | 57 | 49 |
| LiMn₂O₄ | Li₄Ti₅O₁₂ | 2.8 | 1.5 | 29 | 81 | 83 | 29 | 40 | 34 |
| LiCoPO₄ | Li₄Ti₅O₁₂ | 3.6 | 2.5 | 30 | 86 | 87 | 30 | 40 | 30 |
| LiFePO₄ | Li₄Ti₅O₁₂ | 2.5 | 0.3 | 31 | 71 | 73 | 31 | 47 | 39 |
| LiCoPO₄F | Li₄Ti₅O₁₂ | 4.0 | 2.5 | 32 | 80 | 85 | 32 | 41 | 32 |
| LiFePO₄F | Li₄Ti₅O₁₂ | 2.5 | 0.3 | 33 | 79 | 81 | 33 | 55 | 47 |
| LiFeO₂ | Li₄Ti₅O₁₂ | 2.7 | 0.0 | 34 | 77 | 78 | 34 | 52 | 44 |
| V₂O₅ | LiCo_{2.6}O_{0.4}N | 3.1 | 1.0 | 35 | 88 | 88 | 35 | 46 | 37 |

V1*: end-of-charge voltage
V2**: end-of-discharge voltage

Table 3 shows the cycle characteristics (capacity maintenance ratio) and the high-current discharge performance (capacity ratio). In the case where the lithium ion conductor LiPON was used as the solid electrolyte, deterioration of the cycle characteristics became remarkable, suggesting that the decomposition of the solid electrolyte was taken place. In contrast, in the case where the lithium ion conductor of the present invention was used, favorable cycle characteristics were shown and hence it is assumed that the decomposition of the solid electrolyte was not caused. Further, even if a high potential positive electrode such as LiCoPO₄ was used, the deterioration of the cycle characteristics was alleviated by using the lithium ion conductor of the present invention as compared with the case where LiPON was used as the solid electrolyte. Moreover, since the lithium ion conductor of the present invention had high ion conductivity, excellent high-current discharge performance was shown as compared with the case where the solid electrolyte having low ion conductivity was used.

From these results, it is evident that the use of a lithium ion conductor of the present invention as the solid electrolyte allows obtaining an all-solid lithium ion rechargeable battery having excellent cycle characteristics and high-current discharge performance.

In other words, the present invention provides a lithium ion conductor having excellent ion conductivity and high composition voltage. Thus, by using a thin film of the lithium ion conductor as a solid electrolyte, the present invention allows manufacture of an all-solid lithium ion rechargeable battery capable of high-current discharging and showing favorable cycle characteristics.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A lithium ion conductor comprising a composite oxide containing Li, Ta and N.

2. The lithium ion conductor in accordance with claim 1, wherein said composite oxide further contains Nb.

3. The lithium ion conductor in accordance with claim 1, wherein the composition of said composite oxide is represented by the general formula: LiₐNb_{b}Ta_{c}O_{d}Nₑ where 0.1≦a≦2.5, 0≦b<1, 0<c≦1, b+c=1, 0.1≦d≦5 and 0.1≦e≦2.

4. The lithium ion conductor in accordance with claim 3, wherein said general formula further satisfies 0.1≦e≦1.

5. The lithium ion conductor in accordance with claim 3, wherein said general formula further satisfies 0.12≦e≦0.82.

6. An all-solid lithium ion rechargeable battery comprising a positive electrode, a negative electrode and a solid electrolyte interposed between said positive electrode and negative electrode, wherein
said solid electrolyte comprises a lithium ion conductor film, and
said lithium ion conductor film comprises a composite oxide containing Li, Ta and N.

7. The all-solid lithium ion rechargeable battery in accordance with claim 6, wherein said composite oxide further contains Nb.

8. The all-solid lithium ion rechargeable battery in accordance with claim 6, wherein the composition of said composite oxide is represented by the general formula: LiₐNb_{b}Ta_{c}O_{d}Nₑ where 0.1≦a≦2.5, 0≦b<1, 0<c≦1, b+c=1, 0.1≦d≦5 and 0.1≦e≦2.
